(19) United States
(12) Patent Application Publication
(10) Pub. No.: US 2011/0228706 A1
(43) Pub. Date: Sep. 22, 2011

(54) METHOD AND APPARATUS FOR PROVIDING ALARM SERVICE IN A MOBILE DIGITAL BROADCASTING SYSTEM

(75) Inventors: Chang-Hyeon LIM, Seoul (KR); Byoung-Dai LEE, Seongnam-si (KR); Young-Jip KIM, Suwon-si (KR)

(73) Assignee: Samsung Electronics Co., Ltd., Suwon-si (KR)

(21) Appl. No.: 13/053,956

(22) Filed: Mar. 22, 2011

(30) Foreign Application Priority Data
Mar. 22, 2010 (KR) 10-2010-0025098

(51) Int. Cl. H04W 4/06

(52) U.S. Cl. 370/259

(57) ABSTRACT

A method and apparatus for providing an alarm service in a mobile digital broadcasting system are provided. A method of a server for providing an alarm service includes configuring a Service Map Table (SMT) that indicates provision or non-provision of an alarm service, transmitting the SMT, and transmitting an alarm service signal through at least one frequency channel. A method of a Mobile Station (MS) for receiving an alarm service includes receiving an SMT from a broadcasting server, analyzing the received SMT and determining alarm service provision or non-provision, and, when the alarm service provision is determined, receiving an alarm service through a corresponding frequency channel.

### PRIORITY

This application claims priority under 35 U.S.C. §119(a) to a Korean Patent Application filed in the Korean Intellectual Property Office on Mar. 22, 2010, and assigned Serial No. 10-2010-0025098, the contents of which are incorporated herein by reference.

### BACKGROUND OF THE INVENTION

1. Field of the Invention

The present invention generally relates to a mobile digital broadcasting system. More particularly, the present invention relates to a method and apparatus for providing an alarm service to inform of dangerous situations, such as disasters, in a mobile digital broadcasting system.

2. Description of the Related Art

Complexity of mobile digital broadcasting systems continues to increase, with digital broadcasting service systems of various schemes being provided including a Digital Multimedia Broadcasting (DMB) system, a Digital Video Broadcasting—Handheld (DVB-H) system, an Integrated Service Digital Broadcasting—Terrestrial (ISDB-T) system, an Advanced Television Standard Committee—Mobile/Handhelds (ATSC-MH) system and the like.

The ATSC-MH system and the ISDB-T system are similar in that they do not require a separate frequency for mobile digital broadcasting, but the ATSC-MH system has a feature of capable of selecting a bandwidth range for an available service. So, the ATSC-MH system may advantageously provide a mobile broadcasting service by adding only a Mobile Handheld (MH) multiplexer module to an existing digital TeleVision (TV) transmission system.

A standard describing the ATSC-MH system includes main parts of: Part 1 representing a standard summary; Part 2 representing a physical layer; Part 3 representing signaling information for application layer service provision; Part 4 representing a broadcasting information service based on Open Mobile Alliance BroadCAST Electronic Service Guide (OMA BCAST ESG); Part 5 representing an application framework based on Open Mobile Alliance-Rich Media Environment (OMA-RME); Part 6 representing information protection based on Open Mobile Alliance Digital Rights Management (OMA DRM); Part 7 representing a video system describing video compression, closed captioning and the like; and Part 8 representing an audio system. Here, Parts 2, 3, 7, and 8 are items with an MS supported by the ATSC-MH system must necessarily observe to receive a broadcasting service.

Recently, a broadcasting service to inform users of dangerous situations, such as disasters and the like, is becoming important. However, the ATSC-MH system does not separately provide a broadcasting service to inform users of dangerous situations. Thus, there is a need to provide the broadcasting service to inform of dangerous situations in the ATSC-MH system.

### SUMMARY OF THE INVENTION

An aspect of the present invention is to substantially solve at least the above problems and/or disadvantages and to provide at least the advantages below. Accordingly, one aspect of the present invention is to provide a method and apparatus for providing an alarm service in a mobile digital broadcasting system.

Another aspect of the present invention is to provide a method and apparatus for providing an alarm service through each frequency channel or a specific frequency channel in a mobile digital broadcasting system.

A further aspect of the present invention is to provide a method and apparatus for providing an alarm service using a Service Map Table (SMT) indicating signaling information for provision of an application layer service, in a mobile digital broadcasting system.

According to one aspect of the present invention, an operation method of a broadcasting server is provided for receiving an alarm service in a mobile digital broadcasting system. The method includes configuring an SMT that indicates provision or non-provision of an alarm service, transmitting the SMT, and transmitting an alarm service signal through at least one frequency channel.

According to another aspect of the present invention, an operation method of a Mobile Station (MS) is provided for receiving an alarm service in a mobile digital broadcasting system. The method includes receiving an SMT from a broadcasting server, analyzing the received SMT and determining alarm service provision or non-provision, and, when the alarm service provision is determined, receiving an alarm service through a corresponding frequency channel.

According to a further aspect of the present invention, an apparatus of a broadcasting server is provided an alarm service in a mobile digital broadcasting system. The apparatus includes a controller and a communication module. The controller configures an SMT that indicates provision or non-provision of an alarm service. The communication module transmits the SMT, and transmits an alarm service signal through at least one frequency channel.

According to yet another aspect of the present invention, an apparatus of an MS is provided for receiving an alarm service in a mobile digital broadcasting system. The apparatus includes a controller and a communication module. The controller analyzes an SMT received from a broadcasting server, and determines alarm service provision or non-provision. When the alarm service provision is determined, the communication module receives an alarm service through a corresponding frequency channel according to the control of the controller.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram illustrating a construction of a Mobile Station (MS) and a broadcasting server in a digital broadcasting system according to the present invention;

FIG. 2 is a flowchart illustrating operation of a broadcasting server in a digital broadcasting system according to an embodiment of the present invention; and

FIG. 3 is a flowchart illustrating operation of an MS in a digital broadcasting system according to an embodiment of the present invention.

### DETAILED DESCRIPTION OF EMBODIMENTS OF THE PRESENT INVENTION

Embodiments of the present invention are described in detail herein with reference to the accompanying drawings. In the drawings, the same or similar components may be designated by the same or similar reference numerals, though illustrated in different drawings. Further, detailed descriptions of constructions or processes known in the art may be omitted for the sake of clarity and conciseness, and to avoid obscuring the subject matter of the present invention.

Embodiments of the present invention provide a method and apparatus for providing an alarm service for informing users of dangerous situations such as disasters and the like in a mobile digital broadcasting system. The embodiments of the present invention describe, for example, an Advanced Television Standard Committee—Mobile/Handhelds (ATSC-MH) system, and are applicable to other mobile digital broadcasting systems as well. Also, a Mobile Station (MS) is intended to include all information telecommunication equipment and multimedia equipment enabling reception of a broadcasting signal and reproduction thereof. For example, the MS includes a mobile communication terminal, a digital broadcasting terminal, a Personal Digital Assistant (PDA), a smart phone, an International Mobile Telecommunication (IMT)—2000 terminal, a Wideband Code Division Multiple Access (WCDMA) terminal, a Universal Mobile Telecommunication Service (UMTS) terminal and the like.

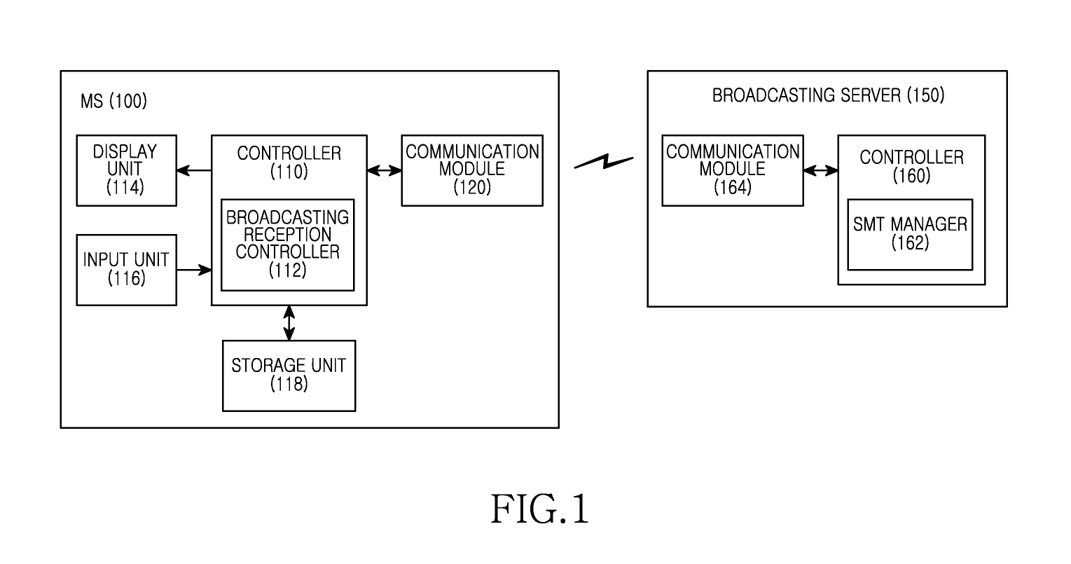

FIG. 1 illustrates a construction of an MS 100 and a broadcasting server 150 in a digital broadcasting system according to the present invention.

Referring to FIG. 1, the MS 100 includes a controller 110, a display unit 114, an input unit 116, a storage unit 118, and a communication module 120. The controller 110 includes a broadcasting reception controller 112.

The controller 110 of the MS 100 controls general operation of the MS 100. The controller 110 includes the broadcasting reception controller 112, thereby controlling the communication module 120 to receive a broadcasting service from the broadcasting server 150.

The broadcasting reception controller 112 controls a function of analyzing a Service Map Table (SMT) received from the broadcasting server 150, determining if an alarm service is provided, acquiring information for alarm service reception when the alarm service is provided, receiving the alarm service, and notifying a user. When there is a change of a version of the SMT received from the broadcasting server 150, the broadcasting reception controller 112 detects the change of service information included in the SMT, and determines if there is information indicating that an alarm service is provided. For example, the broadcasting reception controller 112 determines if a predefined alarm service indication information exists in the SMT or if a flag indicating alarm service provision has been set in the SMT. When there is the information indicating that the alarm service is provided, the broadcasting reception controller 112 collects information (e.g., a broadcaster identifier, frequency information, and ensemble information) for receiving the alarm service and, based on the collected information, controls the communication module 120 to receive the alarm service from the broadcasting server 150. After that, the broadcasting reception controller 112 controls a function for processing an alarm service signal and providing an alarm service to the user through the display unit 114 or a voice output unit (not shown).

The display unit 114 displays state information, numerals, characters, and a variety of videos generated during the operation of the MS 100. According to the present invention, the display unit 114 displays a list of broadcasting services and displays a message received through an alarm service under the control of the broadcasting reception controller 112.

The input unit 116 includes a keypad or a touch sensor to provide data corresponding to a key pressed by a user or a touch screen coordinate touched by the user, to the controller 110. The input unit 116 receives an input of a key or touch for selecting one service from a list of broadcasting services displayed on a screen and provides the received input to the controller 110.

The storage unit 118 stores various programs and data necessary for the operation of the MS 100 and also stores data generated during the operation of the MS 100. Particularly, the storage unit 118 temporarily stores version information of the SMT according to the present invention.

The communication module 120 performs a function of transmitting/receiving and processing a wireless signal of data input/output through an antenna. The communication module 120 includes a broadcasting reception module (not shown) for receiving a digital multimedia broadcasting signal. The broadcasting reception module acquires a broadcaster identifier, a frequency channel, and ensemble information from the broadcasting reception controller 112, and provides the SMT received from the broadcasting server 150, to the broadcasting reception controller 112.

The broadcasting server 150 includes a controller 160 and a communication module 164. The controller 160 also includes an SMT manager 162.

The broadcasting server 150 provides an alarm service through each available frequency channel or may provide the alarm service using a specific frequency channel.

The controller 160 of the broadcasting server 150 controls the general operation of the broadcasting server 150. The controller 160 includes the SMT manager 162, thereby controlling a function for configuring an SMT that indicates information on broadcasting services provided by the broadcasting server 150. Here, when the type and contents of the broadcasting services provided by the broadcasting server 150 change, information configuring the SMT will correspondingly change and accordingly, version information of the SMT is changed.

Particularly, the SMT manager 162 controls a function for informing each MS of alarm service provision or non-provision through the SMT according to the present invention. Here, the SMT, which is a table indicating signaling information for application layer service provision, provides information that is similar to an Electronic Service Guide (ESG). Particularly, the SMT includes minimum information, such as title and access information, for receiving each service.

When the broadcasting server 150 provides the alarm service through each available frequency channel, the SMT manager 162 adds a predefined alarm service indication information to the SMT. At present, a general TV uses ‘0x01’, a radio uses ‘0x02’, Right Issuer service uses ‘0x03’, and a service guide uses ‘0x08’, so the SMT manager 162 is able to use, as the alarm service indication information, one of remaining numerals other than numerals between ‘0x00’ to ‘0x0A’ that are already used.

On the other hand, when the broadcasting server 150 provides the alarm service through the specific frequency channel, the SMT manager 162 indicates the provision or non-provision of the alarm service in the SMT, through a specific flag of the SMT. When the alarm service is provided, the SMT manager 162 adds, to the SMT, information on the frequency channel where the alarm service is provided. For example, the SMT includes information shown in Table 1 below.

TABLE 1

| Syntax | No. of bits | Format |
|---|---|---|
| MH_Component_data( ){ | | |
| dedicated_freq_flag | | |
| If(dedicated_freq_flag==1){ | 1 | ulmsbf |
| Transport_stream_id | | |
| PTC_num | 16 | ulmsbf |
| } | 8 | ulmsbf |
| } | | |

In Table 1, the ‘dedicated_freq_flag’ represents alarm service provision or non-provision, and the ‘Transport_stream_id’ and ‘PTC_num’ represent information on a frequency channel where an alarm service is provided. The ‘Transport_stream_id’, a logic IDentifier (ID) configured by numerals of a range of ‘0x0000-0xFFFF’, generally represents a broadcaster. The ‘PTC_num’, an actual physical frequency, may be configured by 8 bits.

The communication module 164 shown in FIG. 1 transceives and processes a wireless signal of data input/output through an antenna. The communication module 164 includes a broadcasting transmission module (not shown) to transmit a digital multimedia broadcasting signal. The broadcasting transmission module transmits an SMT under the control of the controller 160, and transmits an alarm service signal through each frequency channel or a specific frequency channel.

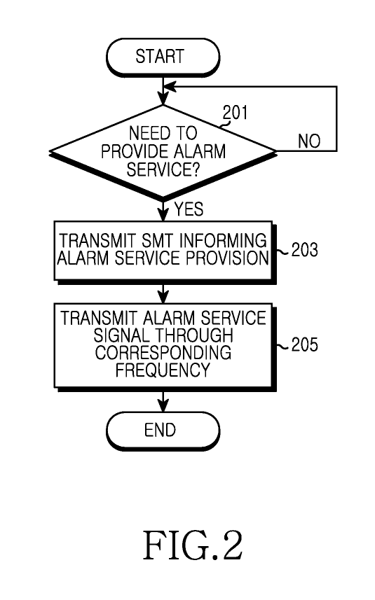

FIG. 2 illustrates operation of a broadcasting server in a digital broadcasting system according to an exemplary embodiment of the present invention.

Referring to FIG. 2, in step 201, the broadcasting server determines whether to provide an alarm service informing a user of dangerous situations such as disasters and the like. If the alarm service is to be provided, the broadcasting server proceeds to step 203 and configures an SMT informing that the alarm service is provided, and transmits the configured SMT to respective MSs. Here, the SMT, which is a table indicating signaling information for application layer service provision, includes minimum information, such as title and access information, for an MS to receive each service. In detail, when the broadcasting server provides an alarm service through each frequency channel, the broadcasting server may add a predefined alarm service instructor to the SMT and, when the broadcasting server provides an alarm service through a specific frequency channel, the broadcasting server may add to the SMT a flag indicating alarm service provision or non-provision and information on the frequency channel where the alarm service is provided. Here, when there is a change of the contents of the SMT as above, the broadcasting server updates a version of the SMT.

Then, in step 205, the broadcasting server transmits an alarm service signal through a corresponding frequency, and terminates the procedure according to the exemplary embodiment of the present invention.

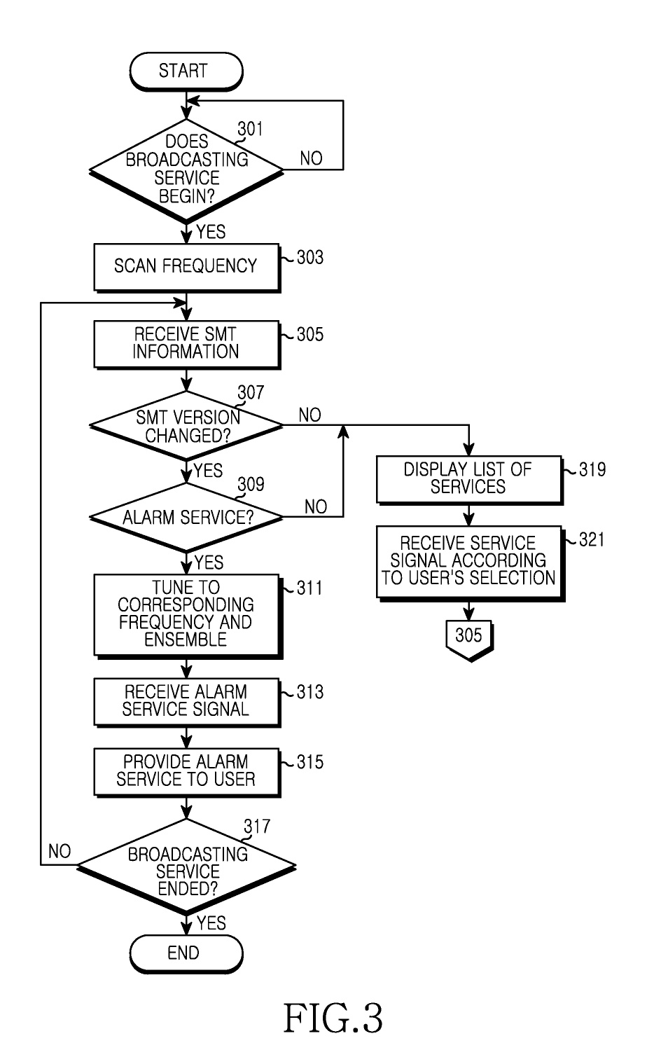

FIG. 3 illustrates operation of an MS in a digital broadcasting system according to an exemplary embodiment of the present invention.

Referring to FIG. 3, if a broadcasting service begins in step 301, the MS proceeds to step 303 and scans a frequency according to a preset scheme. Next, in step 305, the MS receives SMT information from a broadcasting server on the scanned frequency.

Then, in step 307, the MS determines if there is a change of version information of an SMT. That is, the MS compares a version of a previously received SMT with a version of a currently received SMT, determining any change of version information. When the previously received SMT does not exist, the MS proceeds to step 319, and otherwise performs step 307.

If there is no change of the version information of the SMT, at step 319, on the basis of the SMT, the MT configures a list of services provided by the broadcasting server and displays the list of services on a screen. Then, in step 321, the MS receives a signal of a corresponding service according to user selection and reproduces the corresponding service and returns to step 305. If there is no change of the version information of the SMT, the operations of reproducing a service according to user selection are implemented in the same way as the conventional art. Thus, although not illustrated in FIG. 3, when the MS receives and reproduces a specific service in the course of receiving an SMT of the same version information, the MS continues to reproduce the specific service.

When there is a change of the version information of the SMT, the MS proceeds to step 309 and determines if the SMT includes information on an alarm service. That is, the MS determines if the SMT includes an alarm service instructor or if the SMT sets a flag indicating alarm service provision and includes frequency information providing the alarm service, as shown in Table 1.

If the SMT does not include the information on the alarm service, the MS proceeds to step 319.

On the other hand, if the SMT includes the information on the alarm service, in step 311, the MS acquires information on a frequency and ensemble providing the alarm service and tunes a broadcasting reception module to the identified frequency and ensemble. Here, when the alarm service is provided through each available frequency channel, the MS may omit step 311.

Next, the MS proceeds to step 313 and receives an alarm service signal. Then, in step 315, the MS reproduces an alarm service using the received signal, and provides the alarm service to the user.

After that, in step 317, the MS determines whether to end the broadcasting service. When the broadcasting service is not ended by a user, the MS returns to step 305. When the broadcasting service is ended by the user, the MS terminates the procedure.

As described above, exemplary embodiments of the present invention have an effect of, by providing an alarm service through each available frequency channel or a specific frequency channel and informing the alarm service provision using an SMT that indicates signaling information for application layer service provision, being capable of receiving the alarm service in real time irrespective of a characteristic of an MS.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An operation method of a broadcasting server providing an alarm service in a mobile digital broadcasting system, the method comprising:
configuring a Service Map Table (SMT) that indicates provision or non-provision of an alarm service;
transmitting the SMT; and
transmitting an alarm service signal on at least one frequency channel.

2. The method of claim 1, wherein the SMT includes at least one of tile and access information of service provided by the broadcasting server, an alarm service indication information, a flag indicating alarm service provision or non-provision, a broadcaster identifier, alarm service provision frequency information, and version information.

3. The method of claim 2, wherein when the broadcasting server provides an alarm service through each available frequency channel, configuring the SMT comprises:
adding the alarm service instructor to the SMT; and
updating the version information of the SMT.

4. The method of claim 2, wherein when the broadcasting server provides an alarm service through a specific frequency channel, configuring the SMT comprises:
setting the flag indicating the alarm service provision or non-provision;
adding the broadcaster identifier providing the alarm service and the frequency information; and
updating the version information of the SMT.

5. An operation method of a Mobile Station (MS) receiving an alarm service in a mobile digital broadcasting system, the method comprising:
receiving a Service Map Table (SMT) from a broadcasting server;
analyzing the received SMT and determining alarm service provision or non-provision; and
when the alarm service provision is determined, receiving an alarm service on a corresponding frequency channel.

6. The method of claim 5, wherein the SMT includes at least one of tile and access information of service provided by the broadcasting server, an alarm service indication information, a flag indicating alarm service provision or non-provision, a broadcaster identifier, alarm service provision frequency information, and version information.

7. The method of claim 6, wherein analyzing the received SMT and determining the alarm service provision or non-provision is performed when version information of the received SMT is different from version information of a previously received SMT.

8. The method of claim 6, wherein, when the alarm service provision is determined, receiving the alarm service comprises receiving the alarm service through a frequency channel that is currently being accessed.

9. The method of claim 6, wherein when the alarm service provision is determined, receiving the alarm service on the corresponding frequency channel comprises:
acquiring a broadcaster identifier and frequency information from the received SMT; and
receiving the alarm service based on the acquired broadcaster identifier and frequency information.

10. An apparatus of a broadcasting server providing an alarm service in a mobile digital broadcasting system, the apparatus comprising:
a controller for configuring a Service Map Table (SMT) that indicates provision or non-provision of an alarm service; and
a communication module for transmitting the SMT, and transmitting an alarm service signal on at least one frequency channel.

11. The apparatus of claim 10, wherein the SMT includes at least one of tile and access information of service provided by the broadcasting server, an alarm service indication information, a flag indicating alarm service provision or non-provision, a broadcaster identifier, alarm service provision frequency information, and version information.

12. The apparatus of claim 11, wherein, when the broadcasting server provides an alarm service through each frequency channel, the controller adds the alarm service instructor to the SMT and updates the version information of the SMT.

13. The apparatus of claim 11, wherein, when the broadcasting server provides an alarm service through a specific frequency channel, the controller sets the flag indicating the alarm service provision or non-provision, adds the broadcaster identifier providing the alarm service and the frequency information, and updates the version information of the SMT.

14. An apparatus of a Mobile Station (MS) receiving an alarm service in a mobile digital broadcasting system, the apparatus comprising:
a controller for analyzing a Service Map Table (SMT) received from a broadcasting server, and determining alarm service provision or non-provision; and
a communication module for, when the alarm service provision is determined, receiving an alarm service on a corresponding frequency channel according to the control of the controller.

15. The apparatus of claim 14, wherein the SMT includes at least one of tile and access information of service provided by the broadcasting server, an alarm service indication information, a flag indicating alarm service provision or non-provision, a broadcaster identifier, alarm service provision frequency information, and version information.

16. The apparatus of claim 15, wherein, when version information of the received SMT is different from version information of a previously received SMT, the controller analyzes the SMT and determines the alarm service provision or non-provision.

17. The apparatus of claim 15, wherein the communication module receives the alarm service through a frequency channel that is currently being accessed.

18. The apparatus of claim 15, wherein the communication module acquires a broadcaster identifier and frequency information from the received SMT, and receives the alarm service based on the acquired broadcaster identifier and frequency information.
